(19) United States
(12) Patent Application Publication
(10) Pub. No.: US 2025/0303909 A1
(43) Pub. Date: Oct. 2, 2025

(54) ELECTRIC VEHICLE CHARGING SYSTEM COMPRISING PLURALITY OF BATTERIES, AND POWER SUPPLY METHOD USING SAME

(71) Applicant: EVAR Inc., Seongnam-si (KR)

(72) Inventors: Hun LEE, Suwon-si (KR); Dong Hyuk Shin, Seongnam-si (KR); Ki Jae Kim, Seoul (KR)

(73) Assignee: EVAR Inc., Seongnam-si (KR)

(21) Appl. No.: 19/237,464

(22) Filed: Jun. 13, 2025

Related U.S. Application Data
(63) Continuation of application No. PCT/KR2023/017394, filed on Nov. 2, 2023.

(30) Foreign Application Priority Data
Dec. 14, 2022 (KR) 10-2022-0174660

(51) Int. Cl. B60L 53/62; B60L 53/53; B60L 53/63; H02J 7/00

(52) U.S. Cl. CPC B60L 53/62; B60L 53/53; B60L 53/63; H02J 7/0019; H02J 7/0031; H02J 7/00712; H02J 7/007194; B60L 2210/10

(57) ABSTRACT

An electric vehicle charging system comprising a plurality of batteries, and a power supply method using same are provided. In various embodiments, the electric vehicle charging system comprising a plurality of batteries comprises: an electric vehicle charging module including a plurality of battery modules; and a control module for controlling operation of the electric vehicle charging module, wherein, when an electric vehicle is electrically connected to the electric vehicle charging module, the control module controls operation of the electric vehicle charging module such that power that is output from the plurality of battery modules is supplied to the electric vehicle, and individually controls, on the basis of the state of each of the plurality of battery modules, power to be output from each of the plurality of battery modules.

### CROSS-REFERENCE TO RELATED PATENT APPLICATION

This application is a Continuation of International Application No. PCT/KR2023/017394, filed on Nov. 2, 2023, which claims the benefit of Korean Patent Application No. 10-2022-0174660, filed on Dec. 14, 2022, in the Korean Intellectual Property Office, the disclosure of which is incorporated herein in its entirety by reference.

### BACKGROUND ART

Electric vehicles (EVs) are products of a future convergence technology that is receiving attention and investment from governments and companies around the world in line with the global green growth policy. Thus, the vehicle industry is experiencing a rapid shift in market demand from conventional oil-based vehicles to EVs.

### TECHNICAL FIELD

Various embodiments of the present invention relate to an electric vehicle charging system including a plurality of batteries and a power supply method using the same.

As the demand for EVs increases, technology development is also being actively pursued not only for EVs but also for infrastructure (charging devices, power supply networks, etc.) to enable the smooth use of the EVs.

However, as the installation of infrastructures for supporting EVs is relatively lacking, many methods and technologies for charging the plurality of EVs have been developed recently.

Typically, an EV charging method involves installing an EV charging module that includes a battery in an office building or apartment complex, and charging an EV by supplying power from the battery to the EV when the battery is electrically connected to the EV.

However, in the case of conventional EV charging methods, since a battery is charged by receiving power from an external power source in advance and then an EV is charged using the power, and when a state of charge (SoC) of the battery falls to a certain level or less, there is a problem that the EV cannot be charged.

In order to solve the above-described problem, by installing a plurality of batteries in a single EV charging module, a charging capacity of the battery is increased to prevent the occurrence of a problem in which the EV cannot be charged due to an insufficient battery capacity. However, when a plurality of batteries are provided in a single EV charging module, a problem of degrading safety may occur, and there is a problem that a system for managing the plurality of batteries as one battery (e.g., a master battery management system (master BMS)) is additionally required.

In particular, in the case of the system (master BMS) for managing the plurality of batteries as a single battery, the price is very expensive, and a high cost and a long time are required for electrical certification. Therefore, there is a need to develop a method of efficiently supplying power to EVs without using a master BMS.

### DISCLOSURE

### Technical Problem

A problem to be solved by the present invention is for the purpose of solving the conventional problems described above and is directed to providing an electric vehicle charging system using a plurality of batteries, which may stably operate an electric vehicle charging system including a plurality of batteries without a master battery management system (BMS) by merging power of the plurality of battery modules and supplying the merging power to the electric vehicle when the battery modules are electrically connected to the electric vehicle, while individually controlling an operation of the plurality of battery modules, that is, individually determining whether to operate the plurality of battery modules or determining a value of the power output from each of the plurality of battery modules on the basis of a state of the plurality of battery modules, and a power supply method using the same.

Another problem to be solved by the present invention is also directed to providing an electric vehicle charging system using a plurality of batteries, which supplies power to an electric vehicle by merging power of a plurality of battery modules when the battery modules are electrically connected to an electric vehicle, and when it is determined that a power supply is impossible because a state of charge (SoC) of a specific battery module falls a certain level or less, not only prevents a situation in which the electric vehicle cannot be charged due to battery power depletion by supplying the power to the electric vehicle using only the remaining battery modules other than a specific battery module among the plurality of battery modules, but also does not require a separate charging time for charging the battery module by supplying external power to a specific battery module while the electric vehicle is charged.

The problems to be solved by the present invention are not limited to the above-described problems, and other problems that are not mentioned can be clearly understood by those skilled in the art from the following description.

### Technical Solution

An electric vehicle charging system including a plurality of batteries according to one embodiment of the present invention to solve the above problems includes an electric vehicle charging module including a plurality of battery modules, and a control module configured to control an operation of the electric vehicle charging module, wherein, when the electric vehicle and the electric vehicle charging module are electrically connected, the control module controls the operation of the electric vehicle charging module to suppl power output from the plurality of battery modules to the electric vehicle and individually controls power output from each of the plurality of battery modules on the basis of a state of each of the plurality of battery modules.

In various embodiments, the electric vehicle charging module may further include a plurality of battery management systems (BMSs), each of which is connected to one of the plurality of battery modules, and configured to individually measure the state of each of the plurality of battery modules, and the control module may individually generate a control command for each of the plurality of battery modules on the basis of the state of each of the plurality of battery modules measured from the plurality of BMSs.

In various embodiments, the state of each of the plurality of battery modules may include a state of charge (SoC) of each of the plurality of battery modules, and the control module may determine a value of power to be output from each of the plurality of battery modules on the basis of the SoC of each of the plurality of battery modules and determine a control command corresponding to each of the plurality of battery modules to output power of the determined value.

In various embodiments, the electric vehicle charging module may further include a first switching module configured to electrically connect or disconnect the electric vehicle to or from each of the plurality of battery modules, and a second switching module configured to electrically connect or disconnect an external power source to or from each of the plurality of battery modules, and the control module may control an operation of the first switching module to disconnect the electric vehicle from at least one battery module so that power output from the at least one battery module is blocked when an SoC of the at least one battery module among the plurality of battery modules becomes less than a reference SoC, and control an operation of the second switching module to connect the external power source to the at least one battery module so that the at least one battery module is charged through power output from the external power source.

In various embodiments, the plurality of battery modules may include a first battery module and a second battery module, and the control module may electrically connect the first battery module to the electric vehicle while electrically connected to the electric vehicle to supply power output from the first battery module to the electric vehicle, and when a an SoC of the first battery module becomes less than a reference charging amount, the control module may disconnect the first battery module from the electric vehicle and electrically connect the second battery module to the electric vehicle so that power output from the second battery module is supplied to the electric vehicle.

In various embodiments, the electric vehicle charging module may further include further includes a capacitor disposed between the first and second battery modules and the electric vehicle and configured to connect the first and second battery modules to the electric vehicle, and may supply power of a predetermined value to the electric vehicle from a time point when the first battery module and the electric vehicle are disconnected to a time point when the second battery module and the electric vehicle are connected and thus the power of the second battery module is supplied to the electric vehicle using power charged in the capacitor when the power output from the first battery module or the second battery module is transferred to the electric vehicle through the capacitor.

In various embodiments, when the SoC of the first battery module becomes less than the reference SoC and thus it is determined that the battery module needs to be replaced, the control module may temporarily interrupt a power supply operation to the electric vehicle, perform a battery module replacement operation (an operation of disconnecting the first battery module from the electric vehicle and connecting the second battery module to the electric vehicle) within a predetermined period of time from a time point when the power supply operation to the electric vehicle is temporarily interrupted, and resume the power supply operation to the electric vehicle when the battery module replacement operation is performed and thus the second battery module and the electric vehicle are connected, and the predetermined period of time may be a time required for the electric vehicle to perform an abnormality determination operation due to a power supply interruption to the electric vehicle.

In various embodiments, the electric vehicle charging module may further include a plurality of DC/DC power modules, each of which is connected to one of the plurality of battery modules, and connected in parallel, and the plurality of DC/DC power modules may control an operation of the battery module connected to each of the plurality of DC/DC power modules according to a control command obtained from the control module.

In various embodiments, the state of each of the plurality of battery modules may include a temperature of each of the plurality of battery modules, and the control module may connect the plurality of battery modules to the electric vehicle while electrically connected to the electric vehicle, and merge power output from the plurality of battery modules to supply the merged power the electric vehicle, and when a temperature of at least one battery module among the plurality of battery modules exceeds a reference temperature, the control module may disconnect the at least one battery module and the electric vehicle.

A power supply method using an electric vehicle charging system including an electric vehicle charging module having a plurality of battery modules and a control module according to another embodiment of the present invention to solve the above problems, the power supply method including electrically connecting the electric vehicle charging module to the electric vehicle, and controlling, by the control module, an operation of the electric vehicle charging module, merging power output from the plurality of battery modules, and supplying the merged power to the electric vehicle, wherein the supplying of the merged power to the electric vehicle may include individually controlling the power output from each of the plurality of battery modules on the basis of a state of each of the plurality of battery modules.

The details of other exemplary embodiments of the present invention are included in the detailed description and the accompanying drawings.

### Advantageous Effects

According to various embodiments of the present invention, there is an advantage of stably operating an electric vehicle charging system using a plurality of batteries, which can stably operate an electric vehicle charging system including a plurality of batteries without a master battery management system (BMS) by merging power of the plurality of battery modules and supplying the merged power to the electric vehicle when the battery modules are electrically connected to the electric vehicle, while individually controlling an operation of the plurality of battery modules, that is, individually determining whether to operate the plurality of battery modules or determining a value of the power output from each of the plurality of battery modules on the basis of a state of the plurality of battery modules, and a power supply method using the same

In addition, there is an advantage of being able to increase time efficiency in that power is supplied to an electric vehicle by merging power of a plurality of battery modules when the battery modules are electrically connected to an electric vehicle, and when it is determined that a power supply is impossible because a SoC of a specific battery module falls a certain level or less, not only prevents a situation in which the electric vehicle cannot be charged due to battery power depletion by supplying the power to the electric vehicle using only the remaining battery modules other than a specific battery module among the plurality of battery modules, but also does not require a separate charging time for charging the battery module by supplying external power to a specific battery module while the electric vehicle is charged.

It should be noted that effects of the present invention are not limited to the above described effect, and other effects of the present invention that are not mentioned above can be clearly understood by those skilled in the art from the above description.

### DESCRIPTION OF DRAWINGS

FIG. 1 is a diagram illustrating an electric vehicle charging system according to one embodiment of the present invention.

FIG. 2 is a flowchart illustrating a power supply method using an electric vehicle charging system including a plurality of batteries according to another embodiment of the present invention.

FIG. 3 is a diagram illustrating a process of collecting state information of a battery module in various embodiments.

FIG. 4 is a diagram illustrating a process of merging power output from the plurality of battery modules and supplying the merged power to an electric vehicle in various embodiments.

FIGS. 5A and 5B are a diagram illustrating a process of supplying power through any one battery module on the basis of a state of charge (SoC) of the battery module in various embodiments.

FIG. 6 is a flowchart illustrating a method of supplying power to an electric vehicle by sequentially using the plurality of battery modules in various embodiments.

FIGS. 7A and 7B are a diagram illustrating a process of supplying power by sequentially using the plurality of battery modules in various embodiments.

FIG. 8 is an exemplary diagram illustrating an electric vehicle charging system including a capacitor in various embodiments.

FIG. 9 is a diagram illustrating a hardware configuration of a control module included in the electric vehicle charging system according to another embodiment of the present invention.

### MODES OF THE INVENTION

Advantages and features of the present invention and methods for achieving them will be made clear from embodiments described in detail below with reference to the accompanying drawings. The present invention may, however, be implemented in many different forms and should not be construed as being limited to the embodiments set forth herein, and the embodiments are provided such that this disclosure will be thorough and complete and will fully convey the scope of the present invention to those skilled in the art to which the present invention pertains, and the present invention is defined by only the scope of the appended claims.

Terms used herein are for the purpose of describing the embodiments and are not intended to limit the present invention. In the present specification, the singular forms include the plural forms unless the context clearly dictates otherwise. It is noted that the terms “comprises” and/or “comprising” used herein does not exclude the presence or addition of one or more other components in addition to stated components. The same reference numerals refer to the same components throughout this disclosure, and the term “and/or” includes each of the stated components and one or more combination thereof. Although the terms first, second, and the like are used to describe various components, these components are substantially not limited by these terms. These terms are used only to distinguish one component from another component. Therefore, a first component described below may be substantially a second component within the technical spirit of the present invention.

Unless defined otherwise, all terms (including technical and scientific terms) used herein may be used in a sense commonly understood by those skilled in the art to which the present invention pertains. In addition, terms defined in a commonly used dictionary are not to be construed ideally or excessively unless specifically defined explicitly.

The term “part” or “module” used in the specification means a hardware component, such as software, a field programmable gate array (FPGA) or application specific integrated circuit (ASIC), and the “part” or “module” performs certain roles. However, the term “part” or “module” is not a meaning limited to software or hardware. “The “part” or “module” may be formed to be stored in an addressable storage medium or to reproduce one or more processors. Thus, as an example, “part” or “module” includes components such as software components, object-oriented software components, class components, and task components, and processes, functions, attributes, procedures, sub-routines, segments of program code, drivers, firmware, microcodes, circuits, data, database, data structures, tables, arrays, and variables. The functions provided in the components and the “part” or “module” may be combined into a smaller number of components and “part” or “module” or may be further divided into additional components and “part” or “module.”

As shown in the drawings, spatially relative terms “below,” “beneath,” “lower,” “above,” “upper,” and the like can be used to easily describe a correlation between one element and another element. In addition to a direction shown in the drawings, the spatially relative terms should be understood as terms including different directions of components when the components are used or operated. For example, when a component element shown in the drawing is inverted, the component described as being “below” or “beneath” another component may be disposed “above” another component. Consequently, the exemplary term “below” can include all of downward and upward directions. A component can be oriented in a different direction so that the spatially relative terms can be interpreted according to the orientation.

In the present specification, a computer means any type of hardware device including at least one processor and may be construed to also encompass software configurations operating in the hardware device according to an embodiment. For example, a computer may be construed to mean a smartphone, a tablet personal computer (PC), a desktop, a notebook, and all user clients and applications operating in each device, but the present invention is not limited thereto.

Hereinafter, embodiments of the present invention will be described with reference to the accompanying drawings.

Although each operation described in the present specification is described as being performed by a computer, the main body of each operation is not limited thereto, and at least some operations may be performed by different devices according to embodiments.

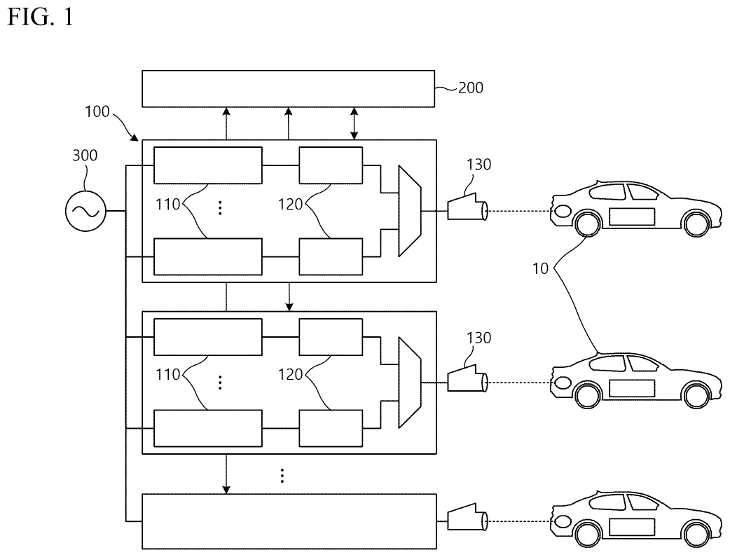

FIG. 1 is a diagram illustrating an electric vehicle charging system according to one embodiment of the present invention.

Referring to FIG. 1, an electric vehicle charging system according to one embodiment of the present invention may include a plurality of electric vehicle charging modules 100, a control module 200, and an external power source 300.

Here, the electric vehicle charging system shown in FIG. 1 is according to one embodiment, and components of the electric vehicle charging system are not limited to the embodiment shown in FIG. 1, and some components may be added, changed, or omitted, as necessary.

In one embodiment, each of the plurality of electric vehicle charging modules 100 may be electrically connected to or disconnected from the electric vehicle and may supply power to the electric vehicle 10 while electrically connected to the electric vehicle 10, thereby charging the electric vehicle 10. To this end, the electric vehicle charging module 100 may include a plurality of battery modules 110, DC/DC power modules 120, and connectors 130. However, the present invention is not limited thereto.

In one embodiment, the plurality of battery modules 110 may be provided inside the electric vehicle charging module 100 and may be electrically connected to the electric vehicle 10 to supply power, which is stored in each of the plurality of battery modules 110, to the electric vehicle 10.

In addition, the plurality of battery modules 110 may be electrically connected to the external power source 300 to receive power from the external power source 300 and charge each of the plurality of battery modules 110 using the power supplied from the external power source 300.

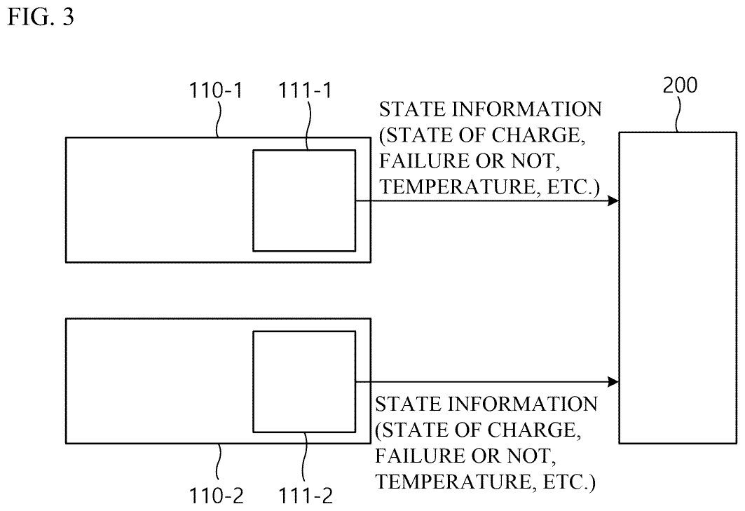

In various embodiments, as shown in FIG. 3, the plurality of battery modules 110 may further include battery management systems (BMSs) 111-1 and 111-2.

The BMSs 111-1 and 111-2 may each be independently connected to one of the plurality of battery modules 110 and may individually measure a state of each of the plurality of battery modules 110. Here, the state of each of the plurality of battery modules 110 may include a state of charge (SoC), whether there is a failure, and a temperature of each of the plurality of battery modules 110, but the present invention is not limited thereto.

In one embodiment, the DC/DC power modules 120 may each be independently connected to one of the plurality of battery modules 110. To this end, the DC/DC power module 120 may be provided as a plurality of DC/DC power modules 120 corresponding to the number of the battery modules 110.

The plurality of DC/DC power modules 120 are connected one-to-one to the plurality of battery modules 110 and may convert power supplied from each of the plurality of battery modules 110 and provide the power to the electric vehicle 10. For example, the plurality of DC/DC power modules 120 may control operations of the battery modules connected one-to-one to the plurality of DC/DC power modules 120 according to a control command obtained from a control module 200, which will be described below, thereby outputting power of a predetermined value from each of the plurality of battery modules 110, and converting the power output from each of the plurality of battery modules 110 to supply the power to the electric vehicle 10.

In this case, the plurality of DC/DC power modules 120 may be mutually connected in parallel to have an effect that the plurality of battery modules 110 are connected in parallel, but the present invention is not limited thereto.

In one embodiment, the connector 130 may be electrically connected to or disconnected from the electric vehicle 10. For example, the connector 130 may be implemented in the form of a charging gun and may be electrically connected to the electric vehicle 10 by being coupled to the electric vehicle 10 through the connector 130 in the form of a charging gun.

Here, for the purpose of simultaneously charging two or more electric vehicles 10 using a single electric vehicle charging module 100, the single electric vehicle charging module 100 may include two or more connectors 130, but the present invention is not limited thereto.

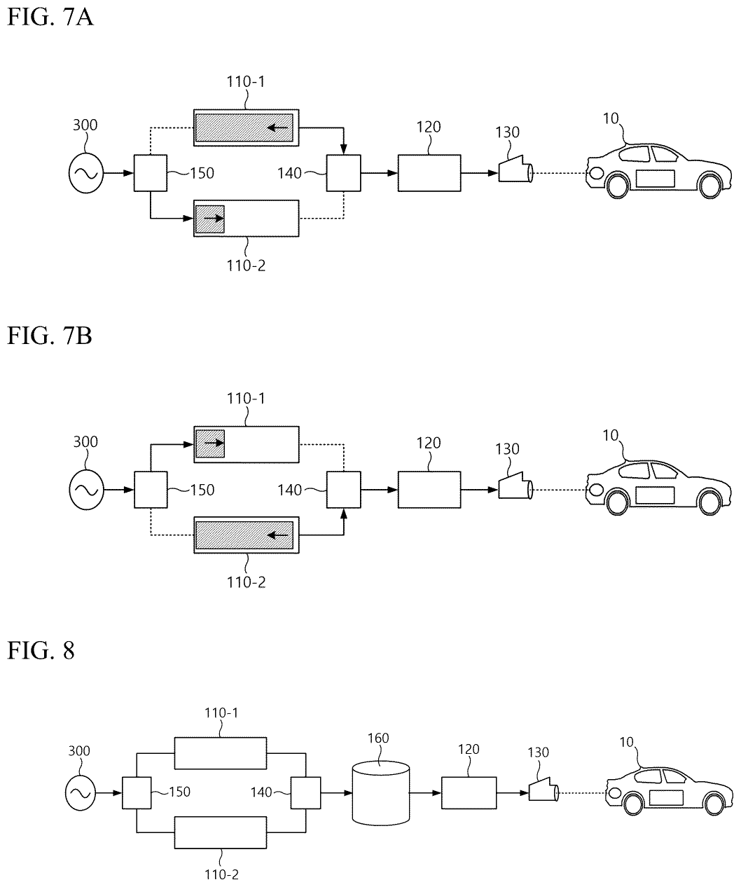

In various embodiments, as shown in FIG. 7, the electric vehicle charging module 100 may further include a first switching module 140 and a second switching module 150.

The first switching module 140 is disposed between the electric vehicle 10 and the plurality of battery modules 110 and may electrically connect or disconnect the electric vehicle 10 to or from each of the plurality of battery modules 110.

The second switching module 150 is disposed between the external power source 300 and the plurality of battery modules 110 and may electrically connect or disconnect the external power source 300 to or from each of the plurality of battery modules 110.

In various embodiments, as shown in FIG. 8, the electric vehicle charging module 100 may further include a capacitor 160.

The capacitor 160 may be disposed between the second switching module 150 and the DC/DC power module 120. The capacitor 160 may be charged using power supplied from at least one of the plurality of battery modules 110, and when the power supplied to the electric vehicle 10 from the battery module 110 is temporarily cut off due to performing a battery module replacement operation, a predetermined value of the power may be supplied to the electric vehicle 10 while performing the battery module replacement operation using the power stored in the capacitor 160.

In various embodiments, the electric vehicle charging module 100 may further include a constant temperature device for temperature balancing of the plurality of battery modules 110, and an AC/DC converter for converting power (e.g., AC 3-phase 21 kW) supplied from the external power source 300 and supplying the power to the plurality of battery modules 110, but the present invention is not limited thereto.

In one embodiment, the control module 200 may control an operation of the electric vehicle charging module 100.

For example, the control module 200 may control an operation of the DC/DC power module 120 to output power of a predetermined value from each of the plurality of battery modules 110 and merge the power of the predetermined values output from the plurality of battery modules 110 to supply the merged power to the electric vehicle 10.

As another example, the control module 200 may control an operation of the first switching module 140 to electrically connect or disconnect the electric vehicle 10 to or from each of the plurality of battery modules 110 or control an operation of the second switching module 150 to electrically connect or disconnect the external power source 300 to or from each of the plurality of battery modules 110.

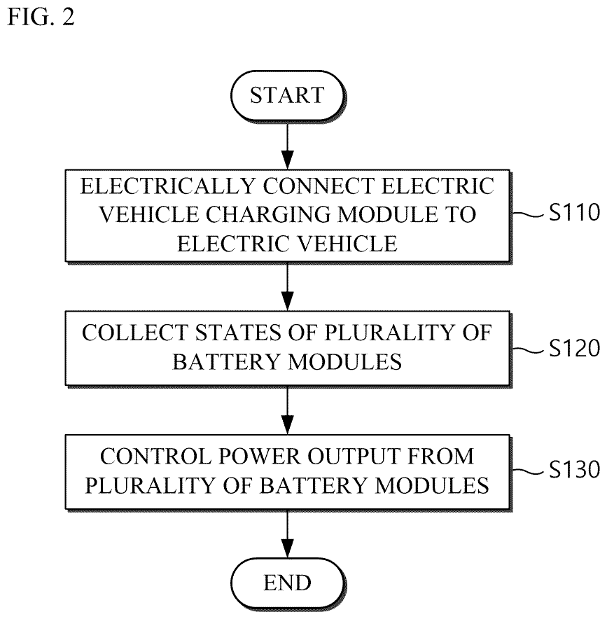

In various embodiments, when the electric vehicle 10 and the electric vehicle charging module 100 are electrically connected, the control module 200 may supply power output from the plurality of battery modules 110 to the electric vehicle 10 by controlling the operation of the electric vehicle charging module 100 and may individually control the power output from each of the plurality of battery modules 110 on the basis of a state of each of the plurality of battery modules 110. Hereinafter, a power supply method performed through the electric vehicle charging system will be described in more detail with reference to FIGS. 2 to 8.

FIG. 2 is a flowchart illustrating a power supply method using an electric vehicle charging system including a plurality of batteries according to another embodiment of the present invention.

Referring to FIG. 2, in operation S110, the electric vehicle charging module 100 and the electric vehicle 10 may be electrically connected.

For example, a user may park a vehicle at a location at which the electric vehicle charging module 100 is installed to connect the electric vehicle 10 to the connector 130 of the electric vehicle charging module 100. Since the electric vehicle 10 and the connector 130 of the electric vehicle charging module 100 are connected, the control module 200 may determine that the electric vehicle charging module 100 and the electric vehicle 10 are electrically connected. However, the present invention is not limited thereto.

In operation S120, states of the plurality of battery modules 110 may be collected.

In various embodiments, when the electric vehicle 10 and the connector 130 of the electric vehicle charging module 100 are connected and thus it is determined that the electric vehicle 10 and the electric vehicle charging module 100 are electrically connected, the control module 200 may collect a state of each of the plurality of battery modules 110 included in the electric vehicle charging module 100.

For example, as shown in FIG. 3, the control module 200 may measure a state of the first battery module 110-1 (e.g., an SoC, a failure or nor, a temperature, etc. of the first battery module 110-1) by controlling the operation of the first BMS 111-1 connected to the first battery module 110-1, measure a state of the second battery module 110-2 (e.g., an SoCt, a failure or not, a temperature, etc. of the second battery module 110-2) by controlling the operation of the second BMS 111-2 connected to the second battery module 110-2, and collect state information of the first battery module 110-1 and the second battery module 110-2 from each of the first BMS 111-1 and the second BMS 111-2. However, the present invention is not limited thereto.

In operation S130, power output from each of the plurality of battery modules 110 may be individually controlled.

In various embodiments, the control module 200 may individually control the power output from each of the plurality of battery modules 110 on the basis of the state of each of the plurality of battery modules 110 collected through operation S120. For example, the control module 200 may individually generate a control command for each of the plurality of battery modules 110 on the basis of the state of each of the plurality of battery modules 110 measured from the plurality of BMSs 111-1 and 111-2 and provide the generated control commands to the DC/DC power modules 120.

More specifically, the control module 200 may determine a value of power to be output from each of the plurality of battery modules 110 on the basis of the SoC of each of the plurality of battery modules 110, determine a control command corresponding to each of the plurality of battery modules 110 to output power of the determined value, and provide the control commands corresponding to the plurality of battery modules 110 to the DC/DC power modules 120 connected to the plurality of battery modules 110, thereby allowing each of the plurality of battery modules 110 to output power of a value determined by the control module 200 through control of the DC/DC power module 120.

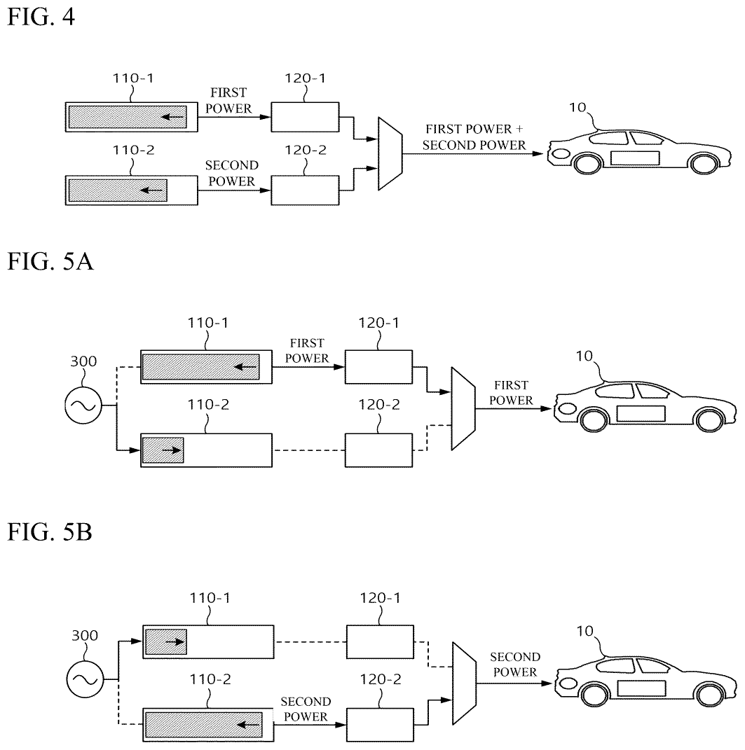

For example, referring to FIG. 4, the control module 200 may determine a first control command to cause the first battery module 110-1 to output a first value of power, i.e., first power, on the basis of the SoC of the first battery module 110-1 and transmit the determined first control command to a first DC/DC power module 120-1 connected to the first battery module 110-1, thereby causing the first battery module 110-1 to output the first power through control of the first DC/DC power module 120-1.

In addition, the control module 200 may determine a second control command to cause the second battery module 110-2 to output power of a second value, i.e., second power, on the basis of the SoC of the second battery module 110-2 and transmit the determined second control command to a second DC/DC power module 120-2 connected to the second battery module 110-2, thereby causing the second battery module 110-2 to output the second power through control of the second DC/DC power module 120-2.

Thereafter, the control module 200 may supply power, which is obtained by merging the first power output from the first battery module 110-1 and the second power output from the second battery module 110-2, to the electric vehicle 10, thereby charging the electric vehicle 10 with the merge of the first power and the second power.

In various embodiments, since the control module 200 is electrically connected to the electric vehicle 10, the control module 200 may set a target power to be supplied to the electric vehicle 10 and may determine a value of power to be output by each of the plurality of battery modules 110 on the basis of the set target power and the SoC of each of the plurality of battery modules 110.

More specifically, first, since the control module 200 is electrically connected to the electric vehicle 10, the control module 200 may set the target power to be supplied to the electric vehicle 10. For example, the control module 200 may set a value of power required for fully charging a battery of the electric vehicle 10 as the target power during the charging time of the electric vehicle 10 on the basis of the SoC of the battery equipped in the electric vehicle 10 and a charging time of the electric vehicle 10, but the present invention is not limited thereto, and the control module 200 may set the target power to be supplied to the electric vehicle 10 on the basis of a cost paid by a user (the cost of charging the electric vehicle 10).

Thereafter, when the plurality of battery modules 110 include the first battery module 110-1 and the second battery module 110-2, the control module 200 may determine a value of power to be output by each of the first battery module 110-1 and the second battery module 110-2 on the basis of the SoC of the first battery module 110-1 and the SoC of the second battery module 110-2.

For example, when the SoCs of the first battery module 110-1 and the second battery module 110-2 are greater than or equal to a first SoC (e.g., 70%), the control module 200 may determine a value of power to be output by each of the first battery module 110-1 and the second battery module 110-2 to be half of the target power, that is, to output power of the same value by each of the first battery module 110-1 and the second battery module 110-2.

As another example, when the SoC of at least one of the first battery module 110-1 and the second battery module 110-2 is less than the first SoC (e.g., 70%), the control module 200 may determine a value of power to be output by each of the first battery module 110-1 and the second battery module 110-2 on the basis of a ratio of the SoC of the first battery module 110-1 to the SoC of the second battery module 110-2. For example, when the SoC of the first battery module 110-1 is 70% and the SoC of the second battery module 110-2 is 50%, a value of power to be output by the first battery module 110-1 may be determined as 7/12 of the target power (approximately 60% of the target power), and a value of power to be output by the second battery module 110-2 may be determined as 5/12 of the target power (approximately 40% of the target power).

As another example, the first battery module 100-1 may output 100% of the target power and the second battery module 110-2, whose temperature is increased, may control a load by lowering the output power to a certain level or less. For example, the output power of the second battery module 110-2, whose temperature increases to a certain level or more, may be reduced to 50% or even to 0%. Of course, the output power level may be controlled according to the battery temperature.

Meanwhile, when the SoC of either the first battery module or the second battery module is completely depleted, the corresponding battery may be performed in a recharge mode and charging may be continued only with the battery having the remaining SoC.

In various embodiments, the control module 200 may merge the power output from the plurality of battery modules 110 to supply the merged to the electric vehicle 10. When a SoC of at least one battery module 110 among the plurality of battery modules 110 is less than a reference SoC, the control module 200 may supply the power to the electric vehicle 10 using only the remaining battery modules 110 other than the at least one battery module 110.

More specifically, as shown in FIG. 4, when the plurality of battery modules 110 include the first battery module 110-1 and the second battery module 110-2, the first power output from the first battery module 110-1 and the second power output from the second battery module 110-2 may be merged and supplied to the electric vehicle 10.

In this case, as shown in FIG. 5A, when the control module 200 supplies the power to the electric vehicle 10 and thus the SoC of the second battery module 110-2 becomes less than a reference SoC (e.g., 10%), the control module 200 disconnects a second battery module 110-2 and the electric vehicle 10 to block the power output from the second battery module 110-2, thereby supplying only the power output from the first battery module 110-1, i.e., the first power, to the electric vehicle 10. In this case, the control module 200 may connect the external power source 300 and the second battery module 110-2 to provide the power supplied from the external power source 300 to the second battery module 110-2, thereby charging the second battery module 110-2 using the power supplied from the external power source 300.

For example, when the SoC of the second battery module 110-2 is less than the reference SoC (e.g., 10%), the control module 200 may control the operation of the first switching module 140 to disconnect the electric vehicle 10 from the second battery module 110-2 so that the power of the second battery module 110-2 so that and may control the operation of the second switching module 150 to connect the external power source 300 to the second battery module 110-2, thereby charging the second battery module 110-2 using the power output from the external power source 300.

That is, when an SoC of a specific battery module 110 among the plurality of battery modules 110 falls less than a certain level and thus the control module 200 determines that it will be difficult to supply the power any longer, the control module 200 supplies the power to the electric vehicle 10 using the remaining battery modules other than the specific battery module that is determined to have difficulty supplying power, thereby having an advantage of being able to continuously supply the power to the electric vehicle 10 without power supply interruption. In addition, by charging the specific battery module with an insufficient SoC using the external power source 300 while the power is supplied to the electric vehicle 10, there is an advantage that a more efficient electric charging system operation is possible such that a separate charging time does not need to be spent to charge the battery module.

Similarly to the above description, as shown FIG. 5B, when the control module 200 supplies the power to the electric vehicle 10 and thus the SoC of the first battery module 110-1 becomes less than the reference SoC (e.g., 10%), the control module 200 may disconnect a first battery module 110-1 and the electric vehicle 10 to block the power output from the first battery module 110-1, thereby supplying only the power output from the second battery module 110-2, i.e., the second power, to the electric vehicle 10, and may connect the external power source 300 and the first battery module 110-1 to provide the power supplied from the external power source 300 to the first battery module 110-1, thereby charging the first battery module 110-1 using the power supplied from the external power source 300 while the power is supplied to the electric vehicle 10.

In various embodiments, as the electric vehicle 10 and the electric vehicle charging module 100 are electrically connected, the control module 200 supplies the power to the electric vehicle 10 by merging the power output from the plurality of battery modules 110 included in the electric vehicle charging module 100 and may supply the merged power to the electric vehicle 10 using only a battery module 110, whose temperature is a reference temperature or less, among the plurality of battery modules 110.

For example, since there is a safety issue because there is a high possibility that a problem such as a fire may occur when the temperature of the battery module exceeds a reference temperature, when it is determined that a temperature of at least one battery module 110 among the plurality of battery modules 110 exceeds the reference temperature, the control module 200 may disconnect at least one battery module 110 and the electric vehicle 10, thereby supplying the power to the electric vehicle 10 using only the remaining battery modules 110 other than the at least one battery module 110.

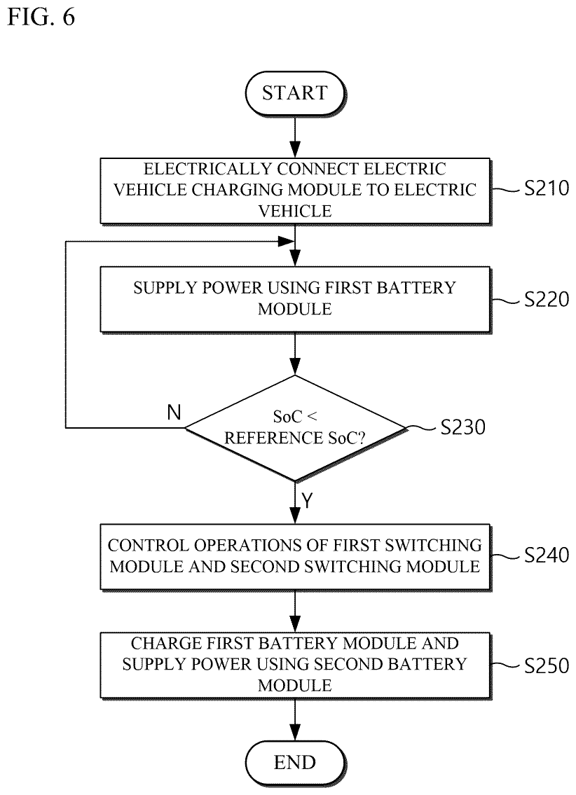

FIG. 6 is a flowchart illustrating a method of supplying power to an electric vehicle by sequentially using the plurality of battery modules in various embodiments.

Referring to FIG. 6, in operation S210, the electric vehicle charging module 100 and the electric vehicle 10 may be electrically connected.

Here, the operation of connecting the electric vehicle charging module 100 and the electric vehicle 10 may be implemented in the form identical or similar to operation S110 of FIG. 2, but the present invention is not limited thereto.

In operation S220, the power may be supplied to the electric vehicle 10 through the first battery module 110-1.

In various embodiments, as shown in FIG. 7A, when it is determined that the electric vehicle 10 and the electric vehicle charging module 100 are electrically connected, the control module 200 may control the operation of the first switching module 140 to connect the electric vehicle 10 to the first battery module 110-1, thereby supplying the power output from the first battery module 110-1 to the electric vehicle 10.

Here, as the electric vehicle 10 and the electric vehicle charging module 100 are electrically connected, the first battery module 110-1 that firstly supplies the power to the electric vehicle 10 may be a battery module, which is predefined to supply the power firstly, among the plurality of battery modules 110, but the present invention is not limited thereto, and the first battery module 110-1 may be a battery module that most recently supplies the power to another electric vehicle 10 previously connected before the currently connected electric vehicle 10, or a battery module having the largest SoC among the plurality of battery modules 110.

In operation S230, it may be determined whether the SoC of the first battery module 110-1 is less than a reference SoC.

In various embodiments, while the power output from the first battery module 110-1 is supplied to the electric vehicle 10, the control module 200 may monitor the SoC of the first battery module 110-1 in real time and determine whether the SoC of the first battery module 110-1 falls less than a preset reference SoC (e.g., 10%).

In this case, when it is determined that the SoC of the first battery module 110-1 is greater than or equal to the reference SoC, the control module 200 may supply the power output from the first battery module 110-1 to the electric vehicle 10. That is, until the SoC of the first battery module 110-1 becomes less than the reference SoC, the control module 200 may supply the power output from the first battery module 110-1 to the electric vehicle 10.

In operation S240, when the SoC of the first battery module 110-1 is less than the reference SoC, the operations of the first switching module 140 and the second switching module 150 may be controlled.

In various embodiments, as shown in of FIG. 7B, when the SoC of the first battery module 110-1 is less than the reference SoC, the control module 200 may control the operation of the first switching module 140 to disconnect the electric vehicle 10 from the first battery module 110-1 and connect the second battery module 110-2 and the electric vehicle 10, thereby supplying the power output from the second battery module 110-2 to the electric vehicle 10.

In addition, when the SoC of the first battery module 110-1 is less than the reference SoC, the control module 200 may control the operation of the second switching module 150 to connect the first battery module 110-1 to the external power source 300 and supply the power output from the external power source 300 to the first battery module 110-1, thereby charging the first battery module 110-1 using the power output from the external power source 300.

In this case, when the control module 200 determines that the battery module needs to be replaced because the SoC of the first battery module 110-1 is less than the reference SoC, the control module 200 controls the operation of the first switching module 140. When the control module 200 switches the battery module supplying the power to the electric vehicle 10 from the first battery module 110-1 to the second battery module 110-2, the first switching module 140. Is operated and thus the power supplied to the electric vehicle 10 may be temporarily blocked during the process of replacing the battery module.

In particular, in a situation in which high power is supplied to the electric vehicle 10, since immediate battery module replacement is impossible, a sufficient transition time is required for replacing the first battery module 110-1 with the second battery module 110-2.

As described above, when the power supply to the electric vehicle 10 is blocked while the battery module is replaced, since a charging session of the electric vehicle 10 may also be cut off, there is a problem that the charging of the electric vehicle 10 may not be performed smoothly.

For the purpose of solving these problems, as shown in FIG. 8, the electric vehicle charging module 100 may further include a capacitor 160 which is disposed between the first and second battery modules 110-1 and 110-2 and the electric vehicle 10 and connects the first and second battery modules 110-1 and 110-2 and the electric vehicle 10.

That is, by supplying power of a predetermined value to the electric vehicle 10 during a transition time that occurs when a battery module replacement operation is performed using power stored in the capacitor 160, that is, from a time point when the first battery module 110-1 and the electric vehicle 10 are disconnected to a time point time when the second battery module 110-2 and the electric vehicle 10 are electrically connected and thus the power output from the second battery module 110-2 is supplied to the electric vehicle 10 so that the power supplied to the electric vehicle 10 may not be blocked, and the electric vehicle 10 may be maintained in a charged state.

Here, the power stored in the capacitor 160 may be charged while the power output from the first battery module 110-1 or the second battery module 110-2 is transferred to the electric vehicle 10 through the capacitor 160, but the present invention is not limited thereto.

Meanwhile, in terms of electric vehicle 10, instead of immediately blocking the charging session at the same time when the power supplied from an external component (e.g., power supplied from the electric vehicle charging module 100) is blocked, an operation of determining an abnormal state is performed for a predetermined period of time when the power supplied from the external component is blocked, and the charging session is blocked on the basis of the result derived from the operation of determining the abnormal state. Thus, a waiting time for a predetermined period of time exists from a time point when the power supplied from the electric vehicle charging module 100 is blocked to a time point when the charging session of the electric vehicle 10 is blocked.

Considering these facts, when the SoC of the first battery module 110-1 becomes less than the reference SoC and thus it is determined that the battery module needs to be replaced, the control module 200 may temporarily interrupts the power supply operation to the electric vehicle 10, perform a battery module replacement operation (e.g., an operation of disconnecting the first battery module 110-1 and the electric vehicle 10 and connecting the second battery module 110-2 and the electric vehicle 10) within a predetermined period from a time point when the power supply operation to the electric vehicle 10 is temporarily interrupted (e.g., a time required for performing the abnormality determination operation in the electric vehicle 10 due to the interruption of the power supply to the electric vehicle 10), and resume the power supply operation to the electric vehicle 10 when the second battery module 110-2 and electric vehicle 10 are connected as the battery module replacement operation is performed.

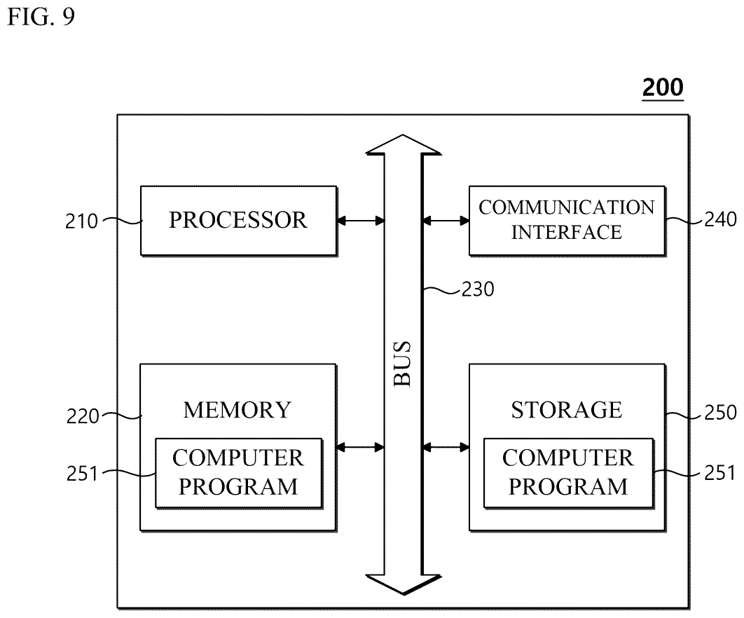

The power supply method through the above-described electric vehicle charging system using a plurality of batteries has been described with reference to the flowchart shown in the drawing. For the simplicity of description, although the power supply method through the electric vehicle charging system using a plurality of batteries has been described by illustrating the power supply method as a series of blocks, the present invention is not limited to the order of the blocks, and some blocks may be performed in a different order or simultaneously than that illustrated and described herein. In addition, new blocks that are not described in the present specification and the drawings are added or the power supply method may be performed in a state in which some blocks are deleted or changed Hereinafter, a hardware configuration of the control module 200 will be described with reference to FIG. 9.

FIG. 9 is a diagram illustrating a hardware configuration of a control module included in the electric vehicle charging system according to another embodiment of the present invention.

Referring to FIG. 9, in various embodiments, the control module 200 may include one or more processors 210, a memory 220 for loading a computer program 251 executed by the processor 210, a bus 230, a communication interface 240, and a storage 250 for storing the computer program 251. Here, only components related to the embodiment of the present invention are shown in FIG. 9. Accordingly, a person skilled in the art will appreciate that the present invention may further include general components other than the components shown in FIG. 9.

The processor 210 controls the overall operation of each component of the control module 200. For example, the processor 210 may include a central processing unit (CPU), a microprocessor unit (MPU), a micro controller unit (MCU), a graphics processing unit (GPU), and an any type of processor well known in the art.

In addition, the processor 210 may perform operations for at least one application or program for executing methods according to embodiments of the present invention, and the control module 200 may include one or more processors.

In various embodiments, the processor 210 may further include a random access memory (RAM) (not shown) and a read-only memory (ROM) (not shown) for temporarily and/or permanently storing signals (or data) processed within the processor 210. In addition, the processor 210 may be implemented in the form of a system on chip (SoC) that includes at least one of a GPU, a RAM, and a ROM.

The memory 220 stores various data, commands, and/or information. In order to execute methods/operations according to various embodiments of the present invention, the memory 220 may load the computer program 251 from the storage 250. When the computer program 251 is loaded in the memory 220, the processor 210 may perform the methods/operations by executing one or more instructions constituting the computer program 251. The memory 220 may be implemented as a volatile memory such as a RAM, but the technical scope of the present invention is not limited thereto.

The bus 230 provides a communication function between the components of the control module 200. The bus 230 may be implemented as various types of buses, such as an address bus, a data bus, and a control bus.

The communication interface 240 supports wired/wireless Internet communication of the control module 200. In addition, the communication interface 240 may support various communication methods other than Internet communication. To this end, the communication interface 240 may include a communication module well known in the technical field of the present invention. In some embodiments, the communication interface 240 may be omitted.

The storage 250 may non-temporarily store the computer program 251. When a power supply process through the electric vehicle charging system using a plurality of batteries is performed through the control module 200, the storage 250 may store various information necessary to provide the power supply process through the electric vehicle charging system using a plurality of batteries.

The storage 250 may include nonvolatile memories such as a ROM, an erasable programmable ROM (EPROM), an electrically erasable programmable ROM (EEPROM), and a flash memory, a hard disk, a removable disk, or any type of computer-readable recording medium well known in the art to which the present invention pertains.

When loaded in the memory 220, the computer program 251 may include one or more instructions that cause the processor 210 to perform the methods/operations according to various embodiments of the present invention. That is, the processor 210 may execute the one or more instructions to perform the methods/operations according to various embodiments of the present invention.

In one embodiment, the computer program 251 may include one or more instructions for performing the power supply method through the electric vehicle charging system using a plurality of batteries, the method including electrically connecting the electric vehicle charging module and the electric vehicle, and merging power output from the plurality of battery modules to supply the merged power to the electric vehicle as the control module controls the operation of the electric vehicle charging module.

The operations of the method or algorithm described in connection with the embodiment of the present invention may be implemented directly in hardware, implemented as a software module executed by hardware, or implemented as a combination of these. The software module may reside in a RAM, a ROM, an EPROM, an EEPROM, a flash memory, a hard disk, a removable disk, a compact disc (CD)-ROM, or any other form of computer readable storage medium well known in the art to which the present invention pertains.

The components of the present invention may be implemented as programs (or applications) to be executed in combination with a computer, which is hardware, and stored in a medium. The components of the present invention may be implemented as software programming or software components and, similarly, the embodiments may include various algorithms implemented in a combination of data structures, processes, routines, or other programming components and may be implemented in a programming or scripting language such as C, C++, Java, or an assembler. Functional aspects may be implemented as algorithms running on one or more processors.

While embodiments of the present invention have been described with reference to the accompanying drawings those skilled in the art can understand that the present invention can be implemented in other specific forms without departing from the technical spirit or the necessary features of the present invention. Therefore, it should be understood that the above-described embodiments are not restrictive but illustrative in all aspects.

1. An electric vehicle charging system including a plurality of batteries, comprising:
an electric vehicle charging module including a plurality of battery modules; and
a control module configured to control an operation of the electric vehicle charging module,
wherein, when the electric vehicle and the electric vehicle charging module are electrically connected, the control module controls the operation of the electric vehicle charging module to supply power output from the plurality of battery modules to the electric vehicle and individually controls the power output from each of the plurality of battery modules on the basis of a state of each of the plurality of battery modules.

2. The electric vehicle charging system of claim 1, wherein:
the electric vehicle charging module further includes a plurality of battery management systems (BMSs), each of which is connected to one of the plurality of battery modules, and configured to individually measure the state of each of the plurality of battery modules; and
the control module individually generates a control command for each of the plurality of battery modules on the basis of the state of each of the plurality of battery modules measured from the plurality of BMSs.

3. The electric vehicle charging system of claim 1, wherein:
the state of each of the plurality of battery modules includes a state of charge (SoC) of each of the plurality of battery modules; and
the control module determines a value of power to be output from each of the plurality of battery modules on the basis of the SoC of each of the plurality of battery modules and determines a control command corresponding to each of the plurality of battery modules to output power of the determined value.

4. The electric vehicle charging system of claim 1, wherein the electric vehicle charging module further includes:
a first switching module configured to electrically connect or disconnect the electric vehicle to or from each of the plurality of battery modules; and
a second switching module configured to electrically connect or disconnect an external power source to or from each of the plurality of battery modules, and
the control module is configured to:
control an operation of the first switching module to disconnect the electric vehicle from at least one battery module so that power output from the at least one battery module is blocked when a state of charge (SoC) of the at least one battery module among the plurality of battery modules becomes less than a reference SoC; and
control an operation of the second switching module to connect the external power source to the at least one battery module so that the at least one battery module is charged through power output from the external power source.

5. The electric vehicle charging system of claim 1, wherein:
the plurality of battery modules includes a first battery module and a second battery module; and
the control module electrically connects the first battery module to the electric vehicle while electrically connected to the electric vehicle to supply power output from the first battery module to the electric vehicle, and when an SoC of the first battery module becomes less than a reference SoC, the control module disconnects the first battery module from the electric vehicle and electrically connects the second battery module to the electric vehicle so that power output from the second battery module is supplied to the electric vehicle.

6. The electric vehicle charging system of claim 5, wherein the electric vehicle charging module further includes a capacitor disposed between the first and second battery modules and the electric vehicle and configured to connect the first and second battery modules to the electric vehicle, and
supplies power of a predetermined value to the electric vehicle from a time point when the first battery module and the electric vehicle are disconnected to a time point when the second battery module and the electric vehicle are connected and thus the power of the second battery module is supplied to the electric vehicle using power charged in the capacitor when the power output from the first battery module or the second battery module is transferred to the electric vehicle through the capacitor.

7. The electric vehicle charging system of claim 5, wherein, when the SoC of the first battery module becomes less than the reference SoC and thus it is determined that the battery module needs to be replaced, the control module temporarily interrupts a power supply operation to the electric vehicle, performs a battery module replacement operation (an operation of disconnecting the first battery module from the electric vehicle and connecting the second battery module to the electric vehicle) within a predetermined period of time from a time point when the power supply operation to the electric vehicle is temporarily interrupted, and resumes the power supply operation to the electric vehicle when the battery module replacement operation is performed and thus the second battery module and the electric vehicle are connected,
wherein the predetermined period of time is a time required for the electric vehicle to perform an abnormality determination operation due to a power supply interruption to the electric vehicle.

8. The electric vehicle charging system of claim 1, wherein:
the electric vehicle charging module further includes a plurality of DC/DC power modules, each of which is connected to one of the plurality of battery modules, and connected in parallel; and
the plurality of DC/DC power modules control an operation of the battery module connected to each of the plurality of DC/DC power modules according to a control command obtained from the control module.

9. The electric vehicle charging system of claim 1, wherein:
the state of each of the plurality of battery modules includes a temperature of each of the plurality of battery modules; and
the control module connects the plurality of battery modules to the electric vehicle while electrically connected to the electric vehicle, and merges power output from the plurality of battery modules to supply the merged power the electric vehicle, and when a temperature of at least one battery module among the plurality of battery modules exceeds a reference temperature, the control module disconnects the at least one battery module and the electric vehicle.

10. A power supply method that is performed through an electric vehicle charging system including an electric vehicle charging module having a plurality of battery modules and a control module, the power supply method comprising:
electrically connecting the electric vehicle charging module to the electric vehicle; and
controlling, by the control module, an operation of the electric vehicle charging module, merging power output from the plurality of battery modules, and supplying the merged power to the electric vehicle,
wherein the supplying of the merged power to the electric vehicle includes individually controlling the power output from each of the plurality of battery modules on the basis of a state of each of the plurality of battery modules.
